(19) United States
(12) Patent Application Publication
(10) Pub. No.: US 2004/0195705 A1
(43) Pub. Date: Oct. 7, 2004

(54) Carburetor

(76) Inventor: Michael P. Burns, Millington, MI (US)

Correspondence Address: REISING, ETHINGTON, BARNES, KISSELLE, P.C., P O BOX 4390, TROY, MI, 48099-4390, US

(21) Appl. No.: 10/406,420

(22) Filed: Apr. 3, 2003

(51) Int. Cl. F02M 7/18

(52) U.S. Cl. 261/59

(57) ABSTRACT

A carburetor has an air intake passage, a fuel passage, a fuel nozzle in communication with the fuel passage and having an opening through which fuel flows, a first valve in communication with the air intake passage and being moveable between first and second positions, and a second valve in communication with the fuel nozzle and also being movable between first and second positions to vary the effective flow area of the fuel nozzle.

### FIELD OF THE INVENTION

This invention relates generally to fuel delivery systems and more particularly to a carburetor.

### BACKGROUND OF THE INVENTION

Carburetors have been used to produce and control the delivery of a fuel and air mixture to an internal combustion engine. Some carburetors have a main body with an air intake passage extending therethrough and a throttle valve disposed in the air intake passage. The throttle valve is moveable between an idle position and a wide open throttle position to control the flow of air through the carburetor.

In so-called butterfly-type carburetors, the throttle valve comprises a generally flat disk rotatable in the intake passage to vary the effective flow area of the air intake passage. Rotation of the throttle valve permits a vacuum pressure signal to act as a function of the position of the throttle valve on a plurality of fuel jets opening into the air intake passage. Thus, movement of the throttle valve controls the flow of fuel out of the various fuel jets whereupon the fuel is mixed with air flowing through the air intake passage. The fuel and air are mixed in the air intake passage and subsequently delivered to an engine to support its operation.

In so-called rotary throttle-type carburetors, a valve chamber extends perpendicular to the air intake passage and a cylindrical throttle valve shaft is received in the valve chamber. A hole through the throttle valve shaft is increasingly aligned with the air intake passage as the throttle valve is rotated from its idle position towards its wide open throttle position to control air flow in the carburetor. A needle carried by the throttle valve shaft is moved relative to a fuel nozzle as the throttle valve is rotated, to vary the effective flow area of the fuel nozzle. In this manner, the flow rate of fuel is adjusted according to the position of the throttle valve, and fuel discharged from the fuel nozzle mixes with air in the air intake passage for delivery of a fuel and air mixture to the engine.

### SUMMARY OF THE INVENTION

A carburetor has an air intake passage, a fuel passage, a first valve in communication with the—air intake passage and being moveable between first and second positions, a second valve in communication with the fuel passage to vary the flow rate of fuel discharged from the fuel passage, and an actuator associated with the first and second valves to cause movement of one of them in response to movement of the other. So constructed and arranged, the first valve controls at least in part the air flow through the carburetor and the second valve controls at least in part the fuel flow from the carburetor.

Preferably, the actuator has a cam assembly associated with both the first and second valves which drives the second valve in response to movement of the first valve. In one form, the second valve has a needle that moves relative to a fuel nozzle opening to vary its effective flow area. In this form, the cam assembly retracts and advances the needle relative to the fuel nozzle in response to movement of the first valve. In one form, the fuel nozzle opening communicates with the air intake passage so that a fuel and air mixture is discharged from the air intake passage for delivery to the engine. In another form, the fuel nozzle opening communicates with a second air passage such that air is discharged from the air intake passage and a fuel and air mixture is discharged from the second air passage for delivery to the engine. Of course, other forms or embodiments of the invention will be apparent to those skilled in the art.

Some of the objects, features and advantages of the invention include providing a carburetor that delivers all of the fuel for delivery to the engine through a single nozzle, has improved idle, rollout, acceleration and come down performance, has improved all position rollout, enables use of an air intake passage without a venturi throat, is readily adjustable, can be used with a fuel passage having a fixed or adjustable orifice, is of relatively simple design and economical manufacture and assembly and has a long useful life in service. Of course, other objects, features or advantages may be realized from the various possible embodiments of the invention, and some embodiments may realize fewer or more than the above listed objects, features and advantages.

### BRIEF DESCRIPTION OF THE DRAWINGS

These and other objects, features and advantages of the present invention will be apparent from the following detailed description of the preferred embodiments, appended claims and accompanying drawings in which:

FIG. 1 is a side view of a carburetor according to a first embodiment of the invention;

FIG. 2 is a perspective view of the carburetor of FIG. 1;

FIG. 3 is a sectional view of the carburetor taken generally along line 3-3 in FIG. 1;

FIG. 4 is a perspective view of the carburetor of FIG. 1 with a portion broken away and in section;

FIG. 5 is an exploded, fragmentary sectional view taken generally along line 5-5 of FIG. 4;

FIG. 6 is a perspective view of a follower used in the carburetor of FIG. 1;

FIG. 7 is a plan view of a valve lever of the carburetor of FIG. 1;

FIG. 8 is a sectional view taken generally along the line 8-8 in FIG. 7;

FIG. 9 is a plan view of a cam assembly of the carburetor of FIG. 1; and

FIG. 10 is a side view with portions broken away and in section of a carburetor according to a second embodiment of the invention.

### DETAILED DESCRIPTION OF THE PREFERRED EMBODIMENTS

Referring in more detail to the drawings, FIGS. 1-9 illustrate a first embodiment of a carburetor 20 that has a body 22, an air intake passage 24 formed in a main block 26 of the body, a first valve 28 associated with the air intake passage 24, a fuel passage 30 having a fuel nozzle 32, and a second valve 34 associated with the fuel nozzle 32. The first valve 28 is moveable between first and second positions to control air flow through the air intake passage 24 and corresponds to idle and wide open throttle engine operation, respectively. The second valve 34 is preferably moved between first and second positions by an actuator in response to movement of the first valve 28 to vary the effective flow area of the fuel nozzle 32 and thereby control the flow rate of fuel discharged from the carburetor. Of course, the second valve 34 could be driven between its first and second positions with the first valve 28 responsive to such movement of the second valve 34 to cause the first valve 28 to rotate between its first and second positions.

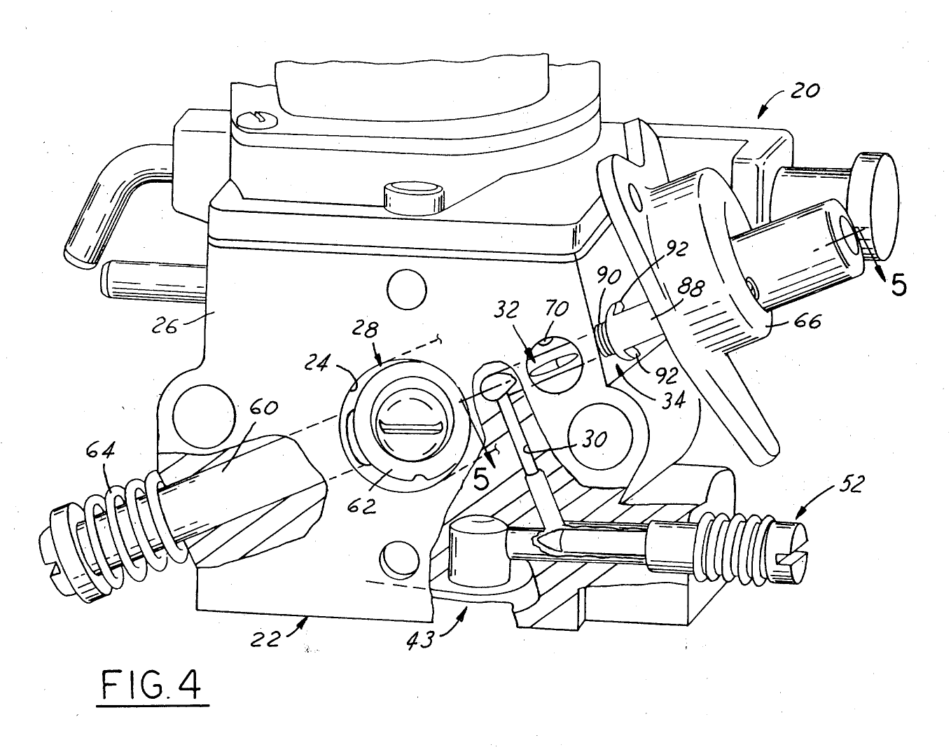

In the embodiment shown, the carburetor 20 is a diaphragm-type carburetor that may utilize a conventional fuel circuit to receive fuel via a diaphragm-type fuel pump assembly and thereafter delivers fuel to a fuel metering assembly defined in part by a fuel metering diaphragm 40 received between the main block 26 and an end plate 42 of the carburetor body 22. The fuel metering assembly and the fuel pump assembly of the carburetor 20 may be constructed as shown and described in U.S. Pat. No. 5,262,092, the disclosure of which is incorporated herein by reference in its entirety. In general, on one side, the diaphragm 40 defines in part a fuel metering chamber 43 (FIG. 4) and on its other side an atmospheric reference chamber (not shown). An inlet valve controls the flow of fuel from the fuel pump into the metering chamber 43, and is actuated by movement of the fuel metering diaphragm 40.

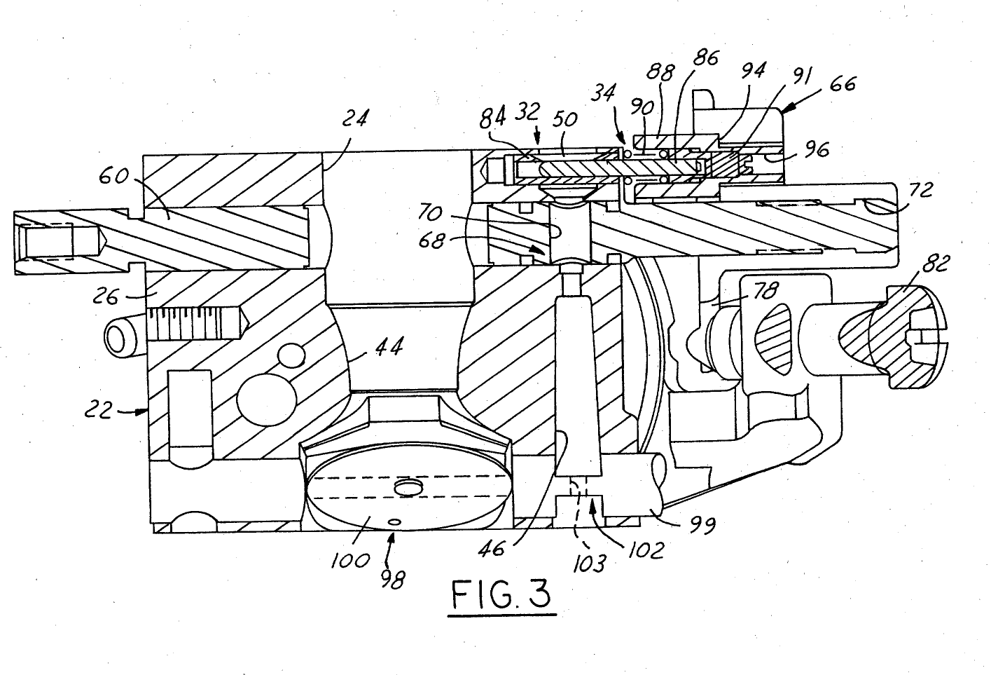

As shown in FIG. 1, the air intake passage 24 extends through a main block 26 of the carburetor body 22 to permit air flow through the carburetor. The air intake passage 24 may have a venturi portion 44 (FIG. 3) providing a reduced diameter throat as is known in the art, or in the alternative, may be a straight cylindrical passage. A second air passage 46 is formed though the carburetor body 22, preferably in the main block 26 parallel to and separate from the air intake passage 24. As shown in FIG. 4, the fuel passage 30 is also formed in the carburetor body 22, preferably, at least in part in the main block 26. The fuel passage 30 communicates at one end with the fuel metering chamber 43 which contains a pool of fuel. At its other end, the fuel passage 30 communicates with the fuel nozzle 32 that is preferably carried by the carburetor body 22 and has an opening 50 through which fuel is discharged for subsequent delivery to an operating engine. Preferably, an adjustment screw 52 is carried by the carburetor body 22, and is preferably threaded in the main block 26 so that an end of the adjustment screw 52 can be moved relative to the fuel passage 30 to control the flow rate of fuel through the fuel passage 30. The fuel passage 30 may also be controlled with a fixed orifice upstream of the nozzle 32 or may not have any orifice or adjustment screw 52 at all.

In the embodiment shown, the fuel nozzle opening 50 is open to the second air passage 46 so that in operation, a fuel and air mixture is delivered from the second air passage 46. Preferably, the nozzle 32 is disposed adjacent to an end of the second air passage 46 adjacent to the engine to increase the vacuum signal at the nozzle during operation of the engine and improve fuel flow through the fuel passage 30 and out of the fuel nozzle 32.

The first valve 28 is associated with the air intake passage 24 and has a valve shaft 60 extending through the main block 26 and the air intake passage 24. The shaft 60 is carried by the carburetor body 22 for rotation between first and second positions corresponding to an idle and wide open throttle engine operating conditions. A valve head 62 is carried by the valve shaft 60 and is preferably a flat disk rotatably received in the air intake passage 24. At idle, the valve head 62 is disposed substantially perpendicular to the air intake passage 24 and permits only a relatively low flow rate of air therethrough. At wide open throttle, the valve head 62 or disk is rotated so that it is generally parallel to the air flow through the intake passage 24 and permits a substantially free flow of air therethrough. A spring 64 on an end of the shaft 60 biases the first valve 28 towards its first position corresponding to idle engine operation. A valve lever 66 is disposed on the other end of the first valve shaft 60 and may be connected to a throttle cable so that the first valve 28 is rotated in response to desired engine performance between idle and wide open throttle. In FIG. 3, the valve shaft 60 is shown without the valve head 62.

As best shown in FIG. 3, the valve shaft 60 has a second valve portion 68 associated with the second air passage 46. The second valve portion 68 has a through bore 70 that is increasingly aligned or registered with the second air passage 46 as the first valve 28 is rotated from its first position toward its second position. When the first valve 28 is in its first position, the second valve portion 68 preferably at least substantially closes the second air passage 46, and when the first valve 28 is in its second position, the second valve portion 68 preferably permits a substantially unrestricted flow therethrough. In this manner, the flow rate of air through the second air passage 46 can be controlled.

As best shown in FIGS. 5, 7 and 8, the valve lever 66 has a bore 72 in which the valve shaft 60 is received, an arcuate slot 74 preferably separate from the bore 72, and an inclined cam surface 76 adjacent to the slot 74. The valve lever 66 also has a pair of outwardly extending flanges 78, 80. One flange 78 is positioned to engage an idle adjustment screw 82 to locate the first valve 28 in its first position, and the other flange 80 is constructed to engage a projection or other stop on the carburetor body 22 to locate the first valve 28 in its second position corresponding to wide open throttle engine operation.

As best shown in FIGS. 1 and 3-5, the second valve 34 is associated with the fuel nozzle 32 and is moveable between first and second positions which control the effective flow area of the opening 50 of the fuel nozzle 32. In this manner, the flow rate of fuel out of the fuel nozzle 32 can be controlled, at least in part. In the embodiment shown, the opening 50 of the fuel nozzle 32 is formed by a slit in a cylindrical tube 84 carried by the body 22 that defines in part the fuel passage 30. The second valve 34 has a needle 86 disposed at least in part in that tube 84 covering at least a portion of the fuel nozzle opening 50 when the second valve 34 is in its first position. The needle 86 is carried by a follower 88 that is yieldably biased by a spring 90 into engagement with the cam surface 76 of the valve lever 66. Desirably, the needle 86 may be threadedly received in the follower 88 to permit axial adjustment of the needle 86 within the fuel passage 30 and relative to the fuel nozzle 32. As shown in FIGS. 3 and 5, the needle 86 may be received in a carrier 91 threadedly carried by the follower 88 for axial adjustment of the needle 86. Of course, the needle 86 may be associated with the follower 88 in other ways with or without any carrier, including being press fit, welded, adhered or may be integrally formed with the follower, as examples.

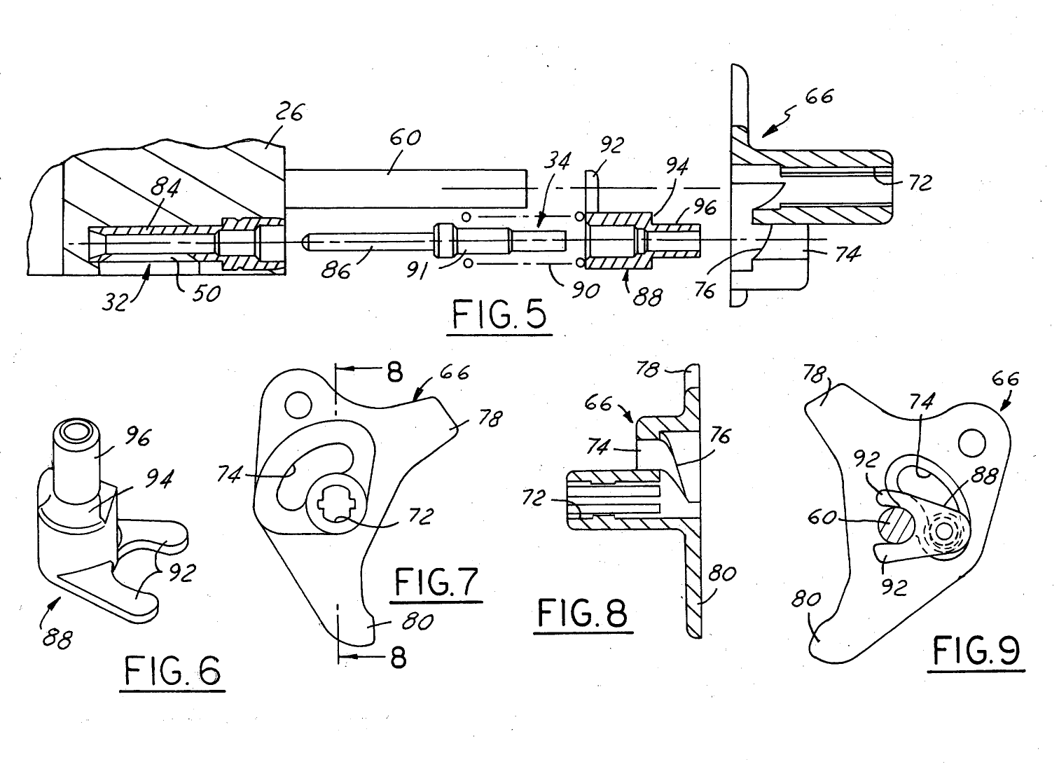

As best shown in FIGS. 6 and 9, the follower 88 preferably has a pair of fingers 92 which straddle the first valve shaft 60 to guide the follower 88 for axial movement parallel to the first valve shaft 60. Preferably, the follower 88 has a radially extending shoulder 94 which engages the cam surface 76, and a cylindrical stem 96 which is received at least partially in the slot 74 formed in the first valve lever 66. An actuator is defined at least in part by the cam assembly which includes, at least in part, the cam surface 76 and follower 88.

Accordingly, when the first valve 28 and its valve lever 66 are rotated in response to a desired change in engine operating conditions, the cam surface 76 is moved relative to the follower which is maintained in engagement with the cam surface 76 by the spring 90. Movement of the inclined cam surface 76 permits axial movement of the follower 88 and hence, the needle 86. This axial movement of the needle 86 changes its position relative to the fuel nozzle opening 50 to alter the effective flow area of the fuel nozzle 32.

When the first valve 28 is rotated from its first position towards its second position, the needle 86 is retracted relative to the fuel nozzle opening 50 to increase its effective flow area and permit increased fuel flow therethrough. At the same time, the bore 70 in the first valve shaft 60 becomes increasing aligned or registered with the second air passage 46 to permit increased airflow therethrough which is mixed with the fuel exiting the fuel nozzle 32 and subsequently delivered to the engine. Also at that same time, the first valve head 62 is rotated relative to the air intake passage 24 to permit an increased air flow therethrough. The fuel and air mixture discharged from the second air passage 46 may be mixed with the air discharged from the air intake passage 24 prior to or after being delivered to the engine. As the first valve 28 is rotated towards its first position, the needle 86 is advanced relative to the opening 50 of the fuel nozzle 32 to decrease its effective flow area and the fuel flow rate therethrough. At the same time, the first valve shaft 60 increasingly restricts the airflow through the second air passage 46, and the valve head 62 increasingly restricts air flow through the air intake passage 24.

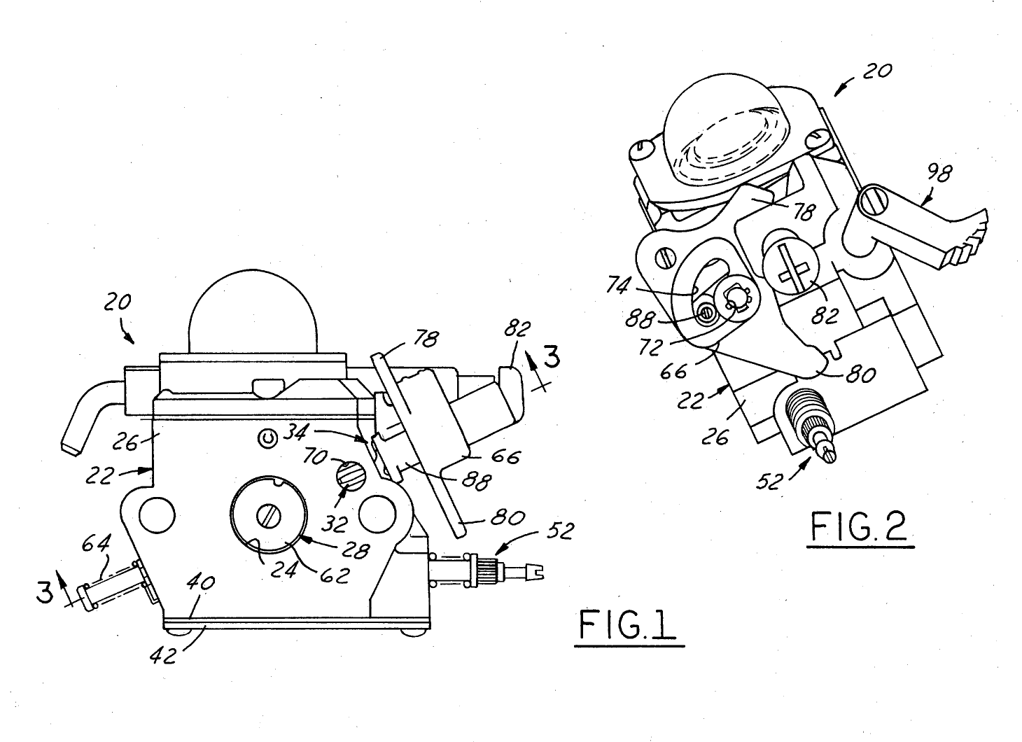

As generally shown in FIGS. 2 and 3, a choke valve 98 may also be utilized with this carburetor 20. The choke valve 98 preferably has a shaft 99, a generally flat first choke valve head 100 on the shaft 99 and disposed in the air intake passage 24, and a second choke valve head 102 disposed in the second air passage 46. As shown in this embodiment, the first choke valve head 100 is a flat, generally circular disk and the second choke valve head 102 is integral with the shaft 99 with a bore 103 in variable alignment or registry with the second air passage 46. When closed, both the first and second valve heads 100, 102 preferably substantially restrict air flow through the air intake passage 24 and the second air passage 46, respectively. When wide open, both the first choke valve head 100 and second choke valve head 102 preferably permit a substantially unrestricted airflow through the air intake passage 24 and the second air passage 46, respectively. The choke valve 98 may have intermediate positions between its closed and fully opened positions as is known in the art.

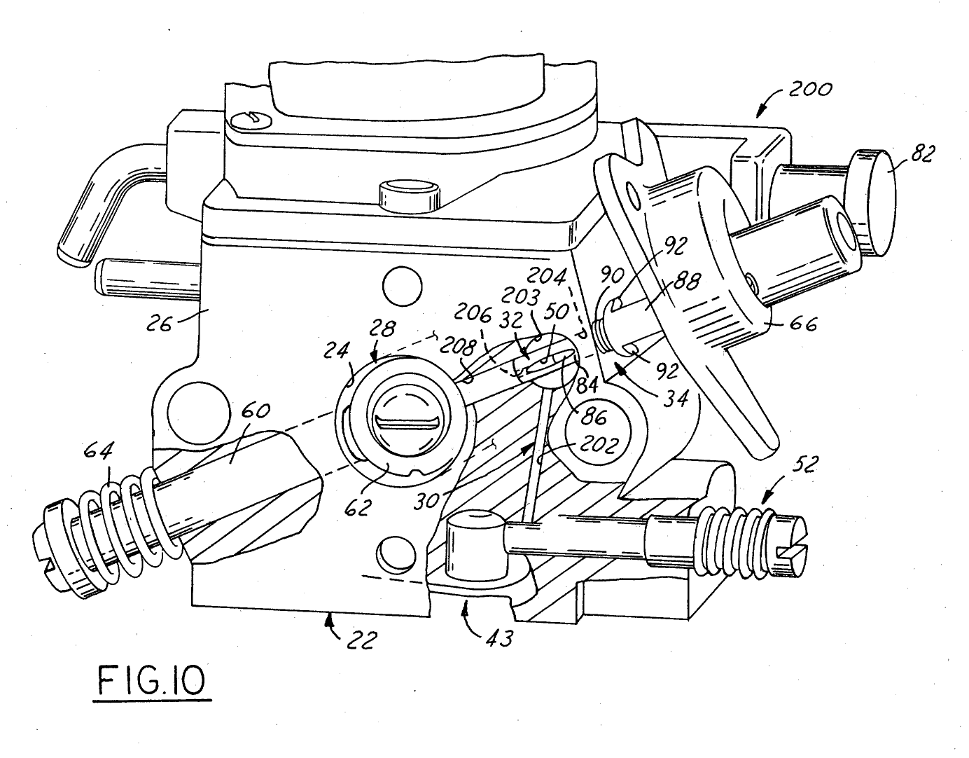

A carburetor 200 according to a second embodiment of the present invention is shown in FIG. 10. As shown, the second embodiment carburetor 200 may be very similar to the first embodiment carburetor 20, and hence the same reference numbers are used to denote similar parts between the embodiments.

As shown in FIG. 10, the second embodiment carburetor 200 does not have a second air passage 46 therethrough. In this embodiment carburetor 200, the fuel passage 30 communicates at one end with a supply of fuel, such as that in a fuel metering chamber 43, and at its other end opens into the air intake passage 24, preferably downstream of the first valve head 62. The fuel passage 30 includes a first portion 202 that communicates at one end with the supply of fuel and at its other end with a bore 203 open to a bore 204 in which the fuel nozzle 32 is received. The fuel nozzle 32 has a second opening 206 at one end that communicates with the opening 50 of the fuel nozzle 32. The second opening 206 also communicates with a second portion 208 of the fuel passage defined by the bore 204 downstream of the fuel nozzle 32.

Therefore, fuel from a fuel supply (such as a fuel metering chamber) flows through the first portion 202 of the fuel passage 30, the bore 203, into the opening 50 of the fuel nozzle, out of the second opening 206 of the fuel nozzle 32 and through the second portion 208 of the fuel passage 30 that opens into the air intake passage 24. Fuel flow is regulated or controlled by at least the needle 86 of the second valve 34 that is slidably received in the tube 84 to vary the effective open area of the opening 50 in the tube 84 of the fuel nozzle 32. The fuel nozzle 32 and second valve 43 may be constructed as set forth in the previous embodiment carburetor 20. The second valve 34 may have the needle 86, follower 88 with fingers 92, spring 90, and stem 96 (not shown in FIG. 10), and the carburetor 20 may have first valve lever 66, and other features as previously described. Accordingly, movement of the first valve 28 is transmitted to the needle 86 via an actuator in a similar manner as in the carburetor 20. Accordingly, in this embodiment, all of the air and fuel is discharged from the carburetor out of the air intake passage 24 for delivery to the engine. Fuel is induced to flow through the flow path described above and into the air intake passage 24 by the vacuum signal provided by the operating engine.

Persons of ordinary skill in the art will recognize that the preceding description of the preferred embodiments of the present invention is illustrative of the present invention and not limiting. Alterations and modifications may be made to the various elements of the carburetor without departing from the spirit and scope of the present invention. For example, and without limitation, while it has been disclosed in the embodiment shown that the second valve is responsive to movement of the first valve, the first valve could be responsive to movement of the second valve. Also, the first and second valves could be constructed differently and may be oriented and arranged in a manner different from that shown in the representative embodiments disclosed. Still other modifications are possible within the spirit and scope of the present invention.

What is claimed is:

1. A carburetor that provides a fuel and air mixture to an engine, comprising:
a body having an air intake passage and a fuel passage in communication with a fuel source;
a first valve having a valve shaft and a valve head disposed in communication with the air intake passage and movable between a first position corresponding to idle engine operation and a second position corresponding to wide open throttle engine operation;
a second valve disposed in communication with the fuel passage and movable between first and second positions to vary the flow rate of fuel discharged from the fuel passage, whereby the first valve controls at least in part the air flow out of the carburetor and the second valve controls at least in part the fuel flow out of the carburetor; and
an actuator associated with the first valve and the second valve to cause movement of one of the first valve and second valve in response to movement of the other of the first valve and second valve.

2. The carburetor of claim 1 which also comprises a fuel nozzle in communication with the fuel passage and having an opening through which fuel flows and wherein the opening of the fuel nozzle communicates with the air intake passage so that fuel that flows through the opening enters the air intake passage.

3. The carburetor of claim 2 wherein the opening of the fuel nozzle communicates with the air intake passage downstream of the first valve.

4. The carburetor of claim 1 wherein the actuator has a cam assembly operably associated with the first valve and the second valve to drive the second valve between its first and second positions in response to movement of the first valve between its first and second positions.

5. The carburetor of claim 4 wherein the cam assembly has a cam surface associated with the first valve and a follower associated with the second valve so that the follower is displaced by the cam surface as the first valve moves.

6. The carburetor of claim 5 which also comprises a fuel nozzle in communication with the fuel passage and having an opening through which fuel flows and wherein the second valve has a needle disposed adjacent to the opening of the fuel nozzle and carried by the follower for movement relative the fuel nozzle to vary the effective flow area of the fuel nozzle.

7. The carburetor of claim 6 wherein the needle extends axially in at least a portion of the fuel passage and is axially moved by the cam assembly.

8. The carburetor of claim 7 wherein the opening of the nozzle is oriented so that fuel flows out of the fuel nozzle at an acute angle relative to path of movement of the needle.

9. The carburetor of claim 6 which also comprises a second opening in the fuel nozzle that is communicated with the air intake passage and wherein fuel enters the fuel nozzle through the opening of the nozzle associated with the needle and exits the fuel nozzle through said second opening.

10. The carburetor of claim 1 which also comprises a second air passage in the body, and wherein the fuel passage communicates with the second air passage to provide fuel into the air passage so that air from the intake passage and fuel and air from the second air passage are provided to the engine.

11. The carburetor of claim 10 wherein the second air passage extends parallel to the air intake passage.

12. The carburetor of claim 10 wherein the second air passage is separate from the air intake passage.

13. The carburetor of claim 6 wherein the needle is adjustably carried by the follower.

14. The carburetor of claim 13 wherein the needle is threaded in the follower for axial adjustment of the position of the needle relative to the follower.

15. The carburetor of claim 5 wherein the follower is yieldably biased into engagement with the cam surface.

16. The carburetor of claim 4 wherein the first valve has a lever to facilitate moving the first valve and the cam surface is formed on the lever.

17. The carburetor of claim 5 wherein the first valve has a valve shaft and a valve head carried by the valve shaft, and the follower has a pair of fingers defining a gap between them in which the valve shaft is received to guide the follower for axial movement parallel to the valve shaft.

18. A carburetor that provides a fuel and air mixture to an engine, comprising:
a body having an air intake passage and a fuel passage in communication with a fuel source;
a fuel nozzle in communication with the fuel passage and having an opening through which fuel for the fuel and air mixture flows;
a first valve having a valve shaft and a valve head carried by the valve shaft in communication with the air intake passage, the first valve is movable between a first position corresponding to idle engine operation and a second position corresponding to wide open throttle engine operation;
a second valve disposed in communication with the fuel nozzle and movable between first and second positions to vary the effective flow area of the fuel nozzle opening, wherein the first valve controls at least in part the air flow out of the carburetor and the second valve controls at least in part the fuel flow out of the carburetor; and
a cam assembly operably associated with the first and second valves to move one of the first and second valves between its first and second positions in response to movement of the other of the first and second valves between its first and second positions.

19. The carburetor of claim 18 wherein the first valve has a valve shaft and a valve head rotatably carried by the valve shaft in the air intake passage to vary the air flow rate through the air intake passage as the first valve moves between its first and second positions.

20. The carburetor of claim 18 wherein the cam assembly comprises a cam surface associated with the first valve and a follower associated with the second valve, whereby the follower is responsive to movement of the cam surface to cause movement of the second valve.

21. The carburetor of claim 18 which also comprises a second air passage in the body, and wherein the fuel nozzle communicates with the second air passage to provide fuel into the second air passage so that air from the intake passage and fuel and air from the second air passage are provided to the engine.

22. The carburetor of claim 21 wherein the second air passage is separate from the air intake passage and does not directly communicate with the air intake passage within the carburetor body.

23. The carburetor of claim 21 wherein the second valve is carried by the body spaced from the air intake passage.
